(19) United States
(12) Patent Application Publication
(10) Pub. No.: US 2016/0279013 A1
(43) Pub. Date: Sep. 29, 2016

(54) SYSTEM AND METHOD FOR CERVICAL TRACTION

(71) Applicant: Bonutti Research, Inc., Effingham, IL (US)

(72) Inventors: Peter M. Bonutti, Manalapan, FL (US); Boris P. Bonutti, Effingham, IL (US); Joseph J. Mathewson, Effingham, IL (US); Glen Phillips, Effingham, IL (US)

(73) Assignee: Bonutti Research, Inc.

(21) Appl. No.: 15/077,602

(22) Filed: Mar. 22, 2016

Related U.S. Application Data
(60) Provisional application No. 62/302,283, filed on Mar. 2, 2016.
(60) Provisional application No. 62/136,938, filed on Mar. 23, 2015.

(51) Int. Cl. A61H 1/02

(52) U.S. Cl. CPC A61H 1/0296; A61H 1/0218; A61H 2201/0119; A61H 2201/1238; A61H 2201/1207; A61H 2201/1607; A61H 2201/1614; A61H 2201/5053

(57) ABSTRACT

A traction system may comprise a head support assembly, a frame assembly, a displacement assembly in mechanical communication with the head support assembly and the frame assembly, an adjustment assembly in mechanical communication with the frame assembly, and a handle assembly. A movement of the head support assembly relative to the frame assembly may apply one or more traction forces to the head and neck of a subject. The displacement assembly may comprise a pulley system, a pneumatic system, a hydraulic system, or any other mechanical system. The displacement assembly may be configured to move the head support assembly relative to the frame assembly. The angle adjustment assembly may be configured to engage a structure of the frame assembly. The handle assembly may be operatively connected to the displacement assembly. The traction system may be used to apply a traction force to a subject's cervical spine.

### CROSS REFERENCE TO RELATED APPLICATION

This application claims priority benefit of U.S. Provisional Application No. 62/136,938 filed on Mar. 23, 2015 and U.S. Provisional Application No. 62/302,283 filed on Mar. 2, 2016. The disclosure of each of the aforementioned applications is incorporated herein by reference.

### FIELD

The present disclosure relates generally to a system and method for cervical traction, more particularly to a device that may be placed on any suitable surface for use in applying traction forces to cervical spinal region.

### BACKGROUND

Many people experience some degenerative condition of the cervical spine or injuries to the cervical spine that may cause neck pain and/or extreme back pain or pressure in the neck, head, or back.

Patients with neck pain due to spinal injuries, particularly cervical spine injuries and cervical muscle strain from various causes, including bad posture during sleep or sitting, as well as from degenerative processes and disc diseases, benefit from intermittent cervical traction. Traction is one of the best and safest treatments used by physical therapist or physician. Traction is a broad term including many treatments involving elongation forces being applied longitudinally to the human torso. While traction is applicable to any part of the body, cervical and lumbar or spinal traction are the most common.

Traction applied to the cervical spine by applying a force to lift the head or a mobilization technique to distract individual joints of the cervical spine. This can be done manually or by a traction device. Cervical traction devices generally operate by applying a traction force to the head and/or neck of a patient. Such devices can relieve pain in the neck and lower back by stretching the cervical and/or lumbar musculature and spine.

Therefore, the traction forces have many clinical applications, including the reduction and immobilization of fractures, the easing, or treatment of muscle spasms, the stretching of soft tissue adhesions, the correction of deformities, the release of musculoskeletal contractures, and the release or alleviation of pinched nerves. There are a number of known devices to provide traction to the cervical spine. Despite of these, there is a need for improved cervical traction device, which would deliver traction force in the case of cervical traction. Such device can be adapted to deliver therapeutic traction force to anatomical regions such as spinal regions including the cervical spinal region, the lumbar spinal region, and the like.

### SUMMARY

In one embodiment, a cervical traction system is provided. The cervical traction system includes a head support assembly, a frame assembly, and a displacement assembly in mechanical communication with the head support assembly and the frame assembly. The cervical traction system also includes an adjustment assembly in mechanical communication with the frame assembly and a handle assembly configured to control the displacement assembly.

In another embodiment, a method of using a cervical traction system is provided. The method of using a cervical traction system includes providing a cervical traction system. The system includes a head support assembly, a frame assembly, a displacement assembly in mechanical communication with the head support assembly and the frame assembly, an adjustment assembly in mechanical communication with the frame assembly, and a handle assembly configured to control the displacement assembly. The method also includes positioning a head and a neck of a subject with respect to the head support assembly the cervical traction system, activating the handle assembly, and moving the head support assembly relative to the frame assembly.

One advantage of the present disclosure allows for rapid rehabilitation of at least a portion of cervical spine. Another advantage of the present disclosure is that the system enables a dynamic stretching mechanism to provide a dynamic stretch of cervical spine joints so that a user may effortlessly use the system.

Yet another advantage of the present disclosure is a system that enables pain-free therapy, virtually eliminating muscle guarding and assuring excellent compliance. Yet another advantage of the present disclosure is a cervical traction system that includes a compression spring for providing adjustable tension to induce greater or lesser tension, pressure, or force on the joint and increase movement of cervical spine. Other advantages of the present disclosure will become apparent from following specification taken in conjunction with the enclosed drawings.

### BRIEF DESCRIPTION OF THE DRAWINGS

The present disclosure will be described with reference to the following drawings. The drawings and the associated descriptions are provided to illustrate embodiments of the disclosure and not to limit the scope of the disclosure:

FIG. 1 is an isometric view of a cervical traction system in accordance with an embodiment of the present disclosure;

FIG. 2 is a perspective top view of a traction device in accordance with an embodiment of the present disclosure;

FIG. 3 is a perspective side view of the traction device in accordance with an embodiment of the present disclosure;

FIG. 4 is a perspective bottom view of the traction device in accordance with an embodiment of the present disclosure;

FIG. 5 is a sectional view of the traction device illustrating a roller assembly in accordance with an embodiment of the present disclosure;

FIG. 6 is another sectional view of the traction device illustrating a roller assembly in accordance with an embodiment of the present disclosure;

FIG. 7 is another sectional view of the traction device illustrating rollers in accordance with an embodiment of the present disclosure;

FIG. 8 is a front view of internal drive assembly of the traction system of the present disclosure;

FIG. 9 is a side view of internal drive assembly of the traction system of the present disclosure;

FIG. 10 is a back view of internal drive assembly of the traction system of the present disclosure;

FIG. 11 is an exploded perspective view of an internal drive assembly of the traction system of the present disclosure;

FIG. 12 is front view of a handle assembly of the traction system of the present disclosure;

FIG. 13 is back view of a handle assembly of traction system of the present disclosure;

FIG. 14 is top view of a handle assembly of the traction system of the present disclosure;

FIG. 15 is sectional view of a handle assembly of the traction system of the present disclosure;

FIG. 16 is an exploded view of a handle assembly of the traction system of the present disclosure;

FIG. 17 is a isometric view of a cervical traction system in accordance with another embodiment of the present disclosure;

FIG. 18 is a perspective top view of the traction device in accordance with another embodiment of the present disclosure;

FIG. 19 is a perspective side view of the traction device in accordance with another embodiment of the present disclosure;

FIG. 20 is a perspective bottom view of the traction device in accordance with another embodiment of the present disclosure;

FIG. 21 is a sectional view of the traction device illustrating side rails in accordance with another embodiment of the present disclosure;

FIG. 22 is a isometric view of cervical a traction system in accordance with further another embodiment of the present disclosure;

FIG. 23 is a perspective bottom view of the traction device in accordance with further embodiment of the present disclosure;

FIG. 24 is a handle assembly of traction system in accordance with further embodiment of the present disclosure; and

FIG. 25 is an exploded view of a handle assembly of traction system in accordance with further embodiment of the present disclosure.

### DETAILED DESCRIPTION

This disclosure is not limited to the particular systems, devices, and methods described, as these may vary. The terminology used in the description is for the purpose of describing the particular versions or embodiments only, and is not intended to limit the scope of the disclosure.

The following terms shall have, for the purposes of this application, the respective meanings set forth below. Unless otherwise defined, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior disclosure.

As used herein and in the appended claims and embodiments, the singular forms “a,” “an,” and “the” include plural references, unless the context clearly dictates otherwise. Thus, for example, reference to a “pulley” is a reference to one or more pulleys and equivalents thereof known to those skilled in the art, and so forth.

As used herein, the term “therapeutic” describes a manipulation, alleviation, or mechanical force applied to treat, combat, ameliorate, prevent, or improve an unwanted condition or disease of a subject. In part, embodiments of the present disclosure are directed to the treatment of injuries, deformities, or other conditions of musculoskeletal structures and the like.

The term “subject” as used herein includes, but is not limited to, humans, non-human vertebrates, and animals such as wild, domestic, and farm animals. In some embodiments, the term “subject” refers to mammals. In some embodiments, the term “subject” refers to humans.

The terms “treat,” “treated,” or “treating” as used herein refer to both therapeutic treatment and prophylactic or preventative measures, wherein the object is to prevent, slow down (lessen), or entirely reverse (eradicate) an undesired physiological condition, disorder or disease, or to obtain beneficial or desired clinical results. For the purposes of this disclosure, beneficial or desired clinical results include, but are not limited to, alleviation of symptoms; diminishment of the extent of the condition, disorder or deformity; stabilization (i.e., not worsening) of the state of the condition, disorder or deformity; delay in onset or slowing of the progression of the condition, disorder or deformity; amelioration of the condition, disorder or deformity; remission (whether partial or total), whether detectable or undetectable, or enhancement or improvement of the condition, disorder, or deformity; and eradication of the condition, disorder, or deformity. Treatment includes eliciting a clinically significant response without excessive levels of side effects.

As used herein, the term “traction” refers to one or more mechanical forces applied to manipulate one or more body parts of a subject. Traction forces may be applied manually or mechanically, or by a combination thereof, such as by a device or system, while one or more counter-traction forces are maintained or applied. Traction forces may be applied to the head, neck, spine, cervical spine, thoracic spine, lumbar spine, sacral spine, torso, pelvis, limbs, or other parts of the user.

Traction forces may be applied to a body part in a neutral position, or in a non-neutral position. Traction forces may be used, for example, to reduce or immobilize fractures, to ease or treat muscle spasms, to stretch soft tissue adhesions, to correct deformities, to release musculoskeletal contractures, to release pinched nerves, or for any other purpose for which such traction force may be deemed useful.

As used herein, the term “counter-traction” refers to a mechanical force applied to counteract one or more traction forces. Counter-traction forces may be applied manually, mechanically, or by a combination thereof, such as by a device or system.

The present disclosure is a traction system to provide traction force to reduce a load of a spine, for example a cervical spine. For example, embodiments herein may be configured to apply a traction force that may distract portions of the spine, for example, to decrease the loading of gravity or weight across the vertebra of the cervical spine. With application of a traction force to distract the spine, the traction forces across the spine may decrease. The traction system and method herein may be configured to neutralize cervical spinal loading and/or distract a portion of the spine.

Although the traction system herein may provide traction force by moving, pulling, or pushing components of the traction system relative to portions of the body, this may result in a decrease in loads of the spine and/or distraction of cervical spine at one or multiple locations.

The traction system and method herein may be configured to provide traction force to distract a portion of a body, for example a neck including a cervical spine of a body. For the purposes of the present application, distraction may include, for example, the application of distance or force to or the movement, stabilization, unloading, or separation of any portion of the body. Traction may include pushing, pulling, or movement along a distance, for example, to distract a portion of the spine. Embodiments may be configured to treat any portion of the body, for example a neck, a spine, a back, a knee, a hip, a finger, a toe, a wrist, an ankle, an elbow, a shoulder, or any other body portion disclosed herein.

Embodiments disclosed herein relate to system and method for providing traction to a portion of the body of a subject. In some embodiments, traction forces may be applied to apportion of the subject's spine. In a preferred embodiment, traction forces may be applied to the subject's cervical spine, including the subject's head and neck. In some embodiments, the traction forces applied to a subject's spine may serve to reduce or eliminate internal or external load on the spine or a portion of the spine, thereby affecting one or more disc spaces, one or more facets, one or more vertebral bodies, or any other component or portion of the spine. In some embodiments, a traction system may be configured to control, adjust, or limit a traction force, traction distance, or traction angle. In some embodiments, the traction system may be positioned for use on any surface, including, for example, a floor, a table, a bed, the ground, or any other surface deemed suitable.

Embodiments of the present disclosure may include a traction system including a stationary base plate, angular neck support assembly, head support assembly, frame assembly, internal drive assembly, angular support assembly, cable assembly and a handle assembly. The frame assembly may be configured to operatively connect the internal drive assembly and handle assembly through cable assembly. The cable assembly comprises one or more wires that operatively connects the handle assembly and drive assembly. The head support assembly mounted on internal drive assembly. A force actuated by a user on the handle assembly may be translated to and/or through internal drive assembly, move the head support assembly relative to frame assembly. Movement of the head assembly relative to the frame assembly may provide a traction force to at least a portion of a body, for example the cervical spine. The angular neck support may be configured operatively connect to the frame assembly for supporting neck of the user.

In use, the stationary base plate may be positioned on any support surface, for example a ground, floor, bed, or table. The slope or traction angle of the angular neck support assembly may be adjusted, for example, by adjusting shoulder adjuster and shoulder up-rest plate on the angular neck support assembly. The head support assembly may include occipital supports and occipital adjuster configured to stabilize a portion of a head of a user. The traction force to be applied may be adjusted by rotating a knob of the handle assembly. The user may position the neck in angular neck support assembly and head in head support assembly. After the user is positioned, the user may then pull the handle and/or rotate a knob of the handle assembly to actuate movement of the internal drive assembly relative to the frame assembly. In addition, the handle assembly may include both the handle and the knob, each providing a different rate of movement between in the internal drive assembly the frame assembly. For example, the handle may be configured to provide finer or more graduated movement than the knob, or vice versa. After actuation of the handle assembly, the internal drive assembly applies a force to the head support assembly relative to the frame assembly, thereby applying traction to distract the vertebra of the cervical spine. The size, dimensions, and/or adjustments of the traction system may be configured to provide a traction force, which may be controlled by the set traction limit.

The present disclosure now will be described with respect to particular embodiments and with reference to the drawings. The drawings described are only schematic and are non-limiting. In the drawings, the size of some of the elements may be exaggerated or distorted and not drawn to scale for illustrative purposes. Indeed, the disclosure may be embodied in many different forms and should not be construed as limited to the embodiments set forth herein; rather, these embodiments are provided so that this disclosure will satisfy applicable requirements.

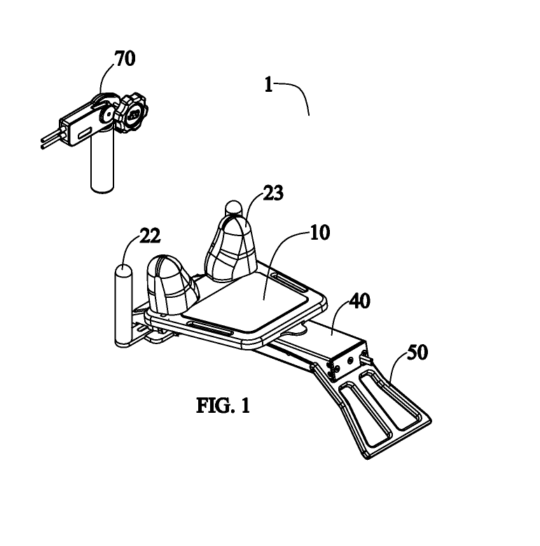

Referring to FIGS. 1-4, cervical traction system 1 includes a traction device 10 and a handle assembly 70. The traction device 10 includes a frame assembly 40, an internal an angular support 50, and a handle assembly 70. Any portion of traction system 10 may include the same or similar components as any of the alternative embodiments disclosed herein including the accompanying drawings.

In one embodiment, the traction device 10 may include a stationary base plate 21 for positioning on a support surface, an angular neck support assembly 20 configured to receive a portion of a neck, and a head support assembly 30. The head support assembly 30 includes occipital supports 23 and an occipital adjuster 31 configured to stabilize a portion of a head of a user. In one embodiment, occipital supports 23 are shaped to conform to the base of the skull (e.g., occipital bone or base of a head or neck) of a subject. In the exemplary embodiment, the occipital supports are fabricated to include a least a portion of foam. Alternatively, the supports 23 can be fabricated from any material that provides support to the head while providing comfortable positioning, including, but not limited to plastic, rubber, cloth, metal, or any combination thereof. The head support assembly 30 also includes a frame assembly 40 configured to operatively connect the head support assembly 30. An internal drive assembly 60 is positioned within the frame assembly 40 to move the head assembly 30 relative to the frame assembly 40. The head assembly 30 also includes an angular support 50 configured to establish an angle between stationary base plate 21 and frame assembly 40.

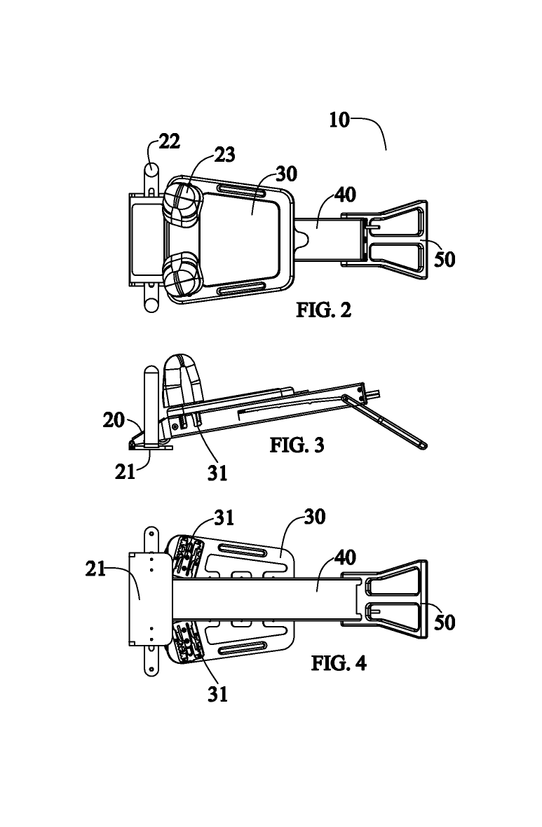

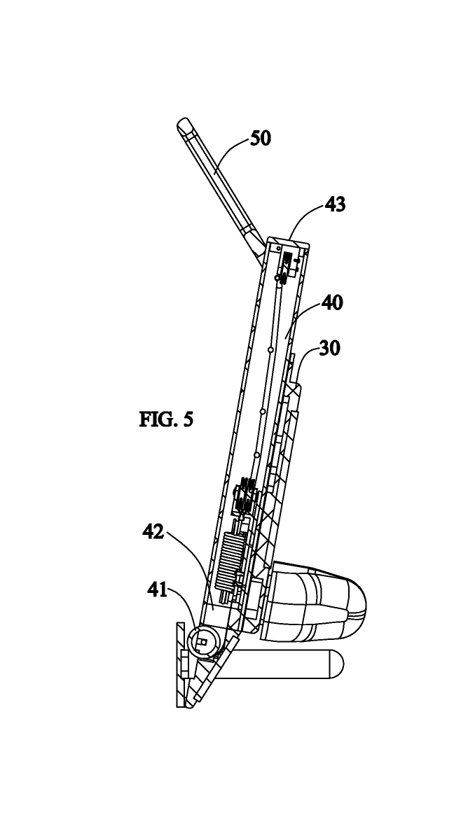

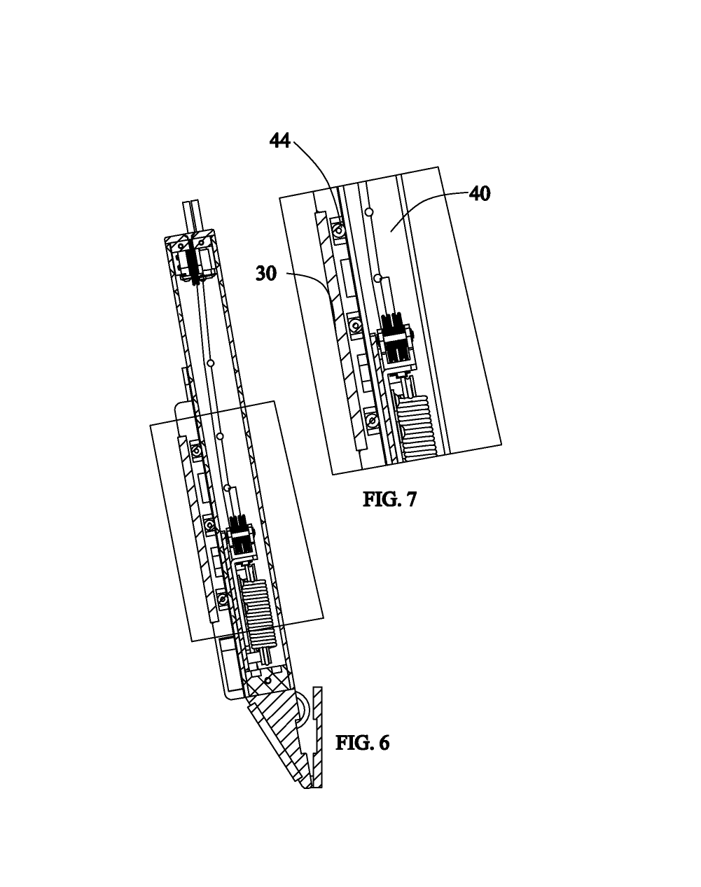

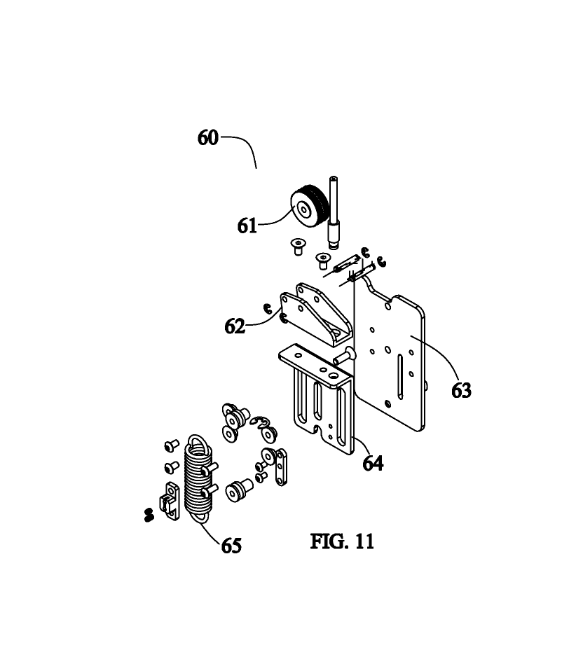

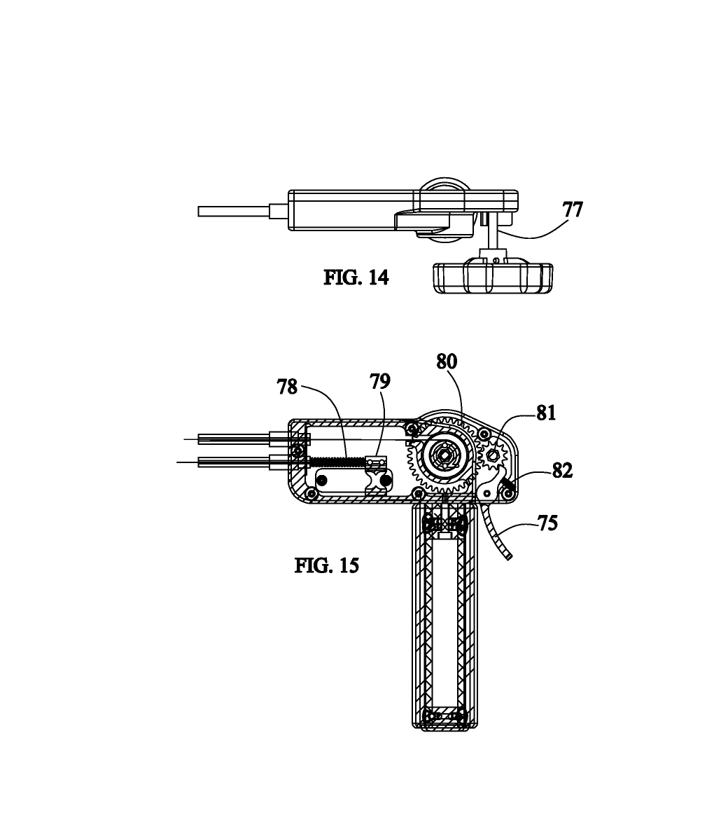

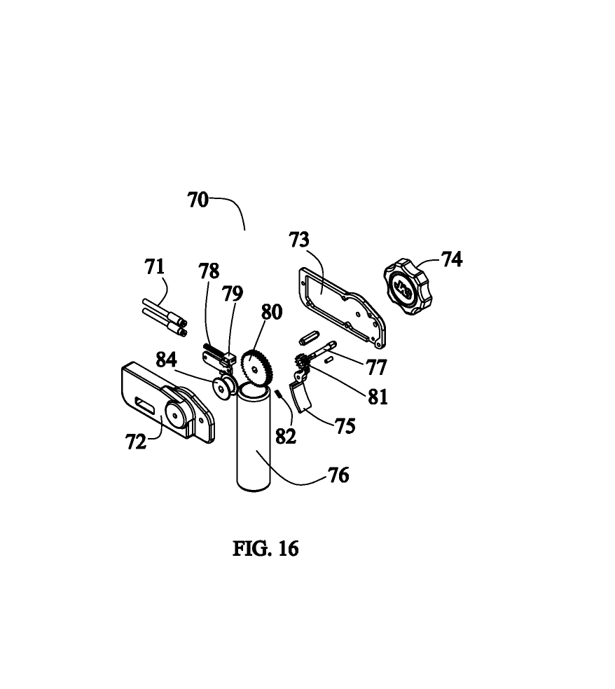

Referring to FIGS. 2-16, the cervical traction system 1 may include a stationary base plate 21 for positioning on a support surface, an angular neck support assembly 20 configured to receive a portion of a neck, a head support assembly 30 configured to engage a portion of a head, and a frame assembly 40 with rollers 44 configured to connect the head support assembly 30. An internal drive assembly 60 is mounted on the frame assembly 40 to move the head assembly 30 relative to the frame assembly 40. The angular support 50 is configured to establish an angle between the stationary base plate 21 and the frame assembly 40. The handle assembly 70 is operatively connected to the internal drive assembly 60 by a cable assembly 71.

In some non-limiting examples, the internal drive assembly 60 may be a pulley system, a pneumatic system, a hydraulic system, a manual system, or a combination thereof. In some non-limiting embodiments, the internal drive assembly 60 may comprise a pulley system that is at one end at least one fixed pulley operatively connected to the frame assembly 40, and at another end, at least one movable pulley operatively connected to the head support assembly 30. The pulley system is operatively connected by one or more cables 71. The head support assembly may move relative to the frame assembly 40 in operation with a pulley system. When a force is translated from the handle assembly 70 to the head support assembly 30, head support assembly 30 moves relative to the frame assembly 40. Movement of the head support assembly 30 relative to the frame assembly 40 may provide a traction force to at least a portion of cervical spine.

One or more additional counter-traction forces may be applied to the head support assembly 30 through a return bias spring assembly, which may include one or more return bias springs. In one non-limiting embodiment, the return bias spring assembly may include a constant force spring. The constant force spring may be coupled to the frame assembly 40 and the head support assembly 30

As the head support assembly 30 moves towards the at least one fixed pulley 125, the constant force spring may unwind, thereby creating a restoring force against the head support assembly. In another non-limiting embodiment, the return bias spring assembly may include a compression spring. In one non-limiting example, the compression spring may connect to the head support assembly 30 with the frame assembly 40. As one example, the compression spring may be connected with the cable with at least one fixed pulley and the at least one movable pulley. In another non-limiting example, a compression spring may be covered in a shroud. The shroud may protect the compression spring from interference, such as from hair of the user.

In one embodiment of the present disclosure, the cervical traction system 1 may include a traction device 10 including a stationary base plate 21, an angular neck support assembly 20, a head support assembly 30, a frame assembly 40, an internal drive assembly 60, an angular support assembly 50, a cable assembly 71, and a handle assembly 70. The stationary base plate 21 may be configured for positioning on a support surface. The angular neck support assembly 20 may be configured to receive a portion of a neck of the user, which is mounted with stationary base plate 21 and further connected with the frame assembly 40 via a mounting block. The frame assembly 40 may be configured with rollers 44 that provide linear movement of the head assembly 30 relative to the frame assembly 40. The frame assembly 40 includes rollers 44 that are attached to edges of frame assembly. These rollers 44 provide support to internal drive assembly 60 for linear movement related to the frame assembly 40. The frame assembly 40 may be configured to connect an angular support 50 to establish an angle between the stationary base plate 21 and the frame assembly 40. The frame assembly 40 comprises a groove in both side for slidably mounting an angular support 50 with screws and blots. The head support may be configured to include occipital supports 23 and occipital adjuster 31 configured to stabilize a portion of a head of a user. The angular neck support assembly 20 may be configured to include shoulder adjuster and shoulder stabilizer 22 to receive a portion of a neck. The shoulder stabilizer 22 is configured to restrict or substantially prevent movement of the shoulders and lower body as the head and neck of a subject are undergoing traction by the movement of the head assembly relative to the frame assembly 40.

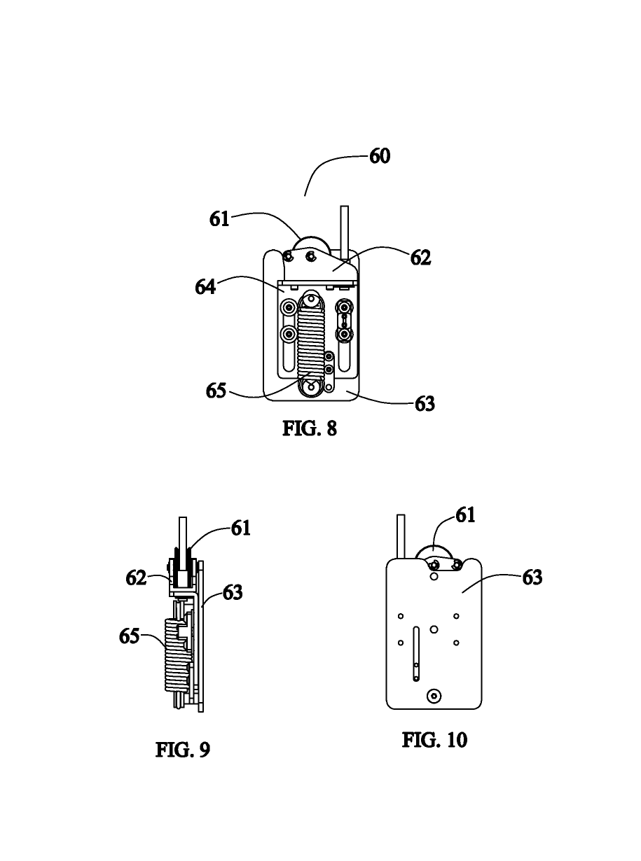

Referring to FIGS. 8-11, in one embodiment, the internal drive assembly 60 includes a pulley system 61, bracket 62, base plate 63, support plate 64, and compression spring 65. As mentioned above, cervical traction system 1 may include cable assembly 71 configured to increase and/or decrease traction. Cable assembly 71 may be configured to increase traction and may be configured to reduce or release traction. Cable assembly 71 may be connected to internal drive assembly 60 to move the head assembly 30. Pulley system 61 is mounted on bracket 62. Base plate 63 may be configured to connect head assembly 30 and frame assembly 40 with screw and bolts. Compression spring 65 is for providing traction force on head assembly 30 translated from handle assembly 70. In one embodiment, the pulley system 61 includes, at one end, at least one fixed pulley operatively connected to the frame assembly 40 and, at another end, at least one movable pulley operatively connected to the head support assembly 30.

In the exemplary embodiment, the handle assembly 70 includes a knob 75 and handle 76. The knob enables movement in the internal drive assembly 60. A force actuated by a user on the knob 75 may be translated to and/or through the internal drive assembly 60 to move the head support assembly 30 relative to the frame assembly 40. Movement of the head assembly 30 relative to the frame assembly 40 may provide a traction force to at least a portion of a body, for example the cervical spine.

The cable assembly 71 comprises one or more wires and/or cables that operatively connect the handle assembly 70 and internal drive assembly 60 on the frame assembly 40. In one embodiment, the head support assembly 30 is mounted on internal drive assembly 60. A force actuated by a user on the handle assembly 70 may be translated to and/or through internal drive assembly 60 to move the head support assembly 30 relative to the frame assembly 40. Movement of the head assembly 30 relative to the frame assembly 40 may provide a traction force to at least a portion of a body, for example the cervical spine.

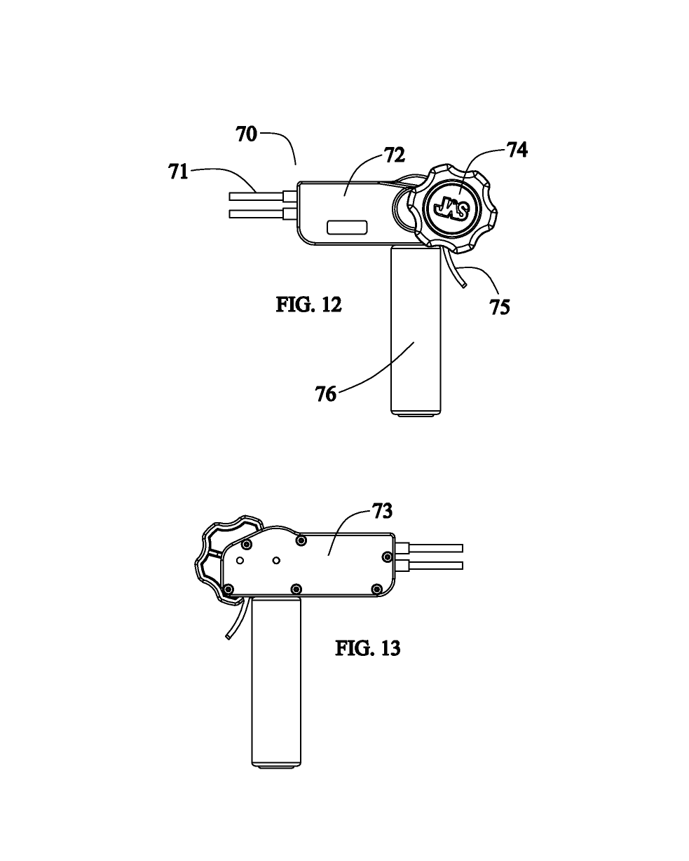

Referring to FIGS. 12-16, the handle assembly 70 may include cable assembly 71, front facing bracket 72, back facing bracket 73, knob 74, pawl 75, and handle 76. The handle assembly also includes a knob shaft 77, compression spring 78, slider 79, knob gear 81, pulley gear 80, spring 82, and pulley 84. Additional embodiments may be configured to reduce or limit traction at a set traction limit, for example with knob 74. Back facing bracket 73 may include indicia or markings corresponding to a relative position of knob 74, which indicate a desired traction limit. In one embodiment, the limits are denoted in terms of pounds (lbs) of force that is applied by the head assembly relative to the frame assembly 40. The traction limit may be based on the amount of force to move the internal drive assembly 60 with cable assembly 71 to meet or exceed the amount of force to compress spring 78 of the handle assembly 70. In the exemplary embodiment, the system 1 enables a subject to provide force in the range of 0-60 lbs of force. In an exemplary embodiment, a compression spring 78 is connected to the cable assembly 71 and a slider 79. The slider 79 is mounted on a fixed plate on which slider 79 may slide during movement of the compression spring 78 (i.e., during winding and rewinding of the compression spring 78) to indicate the force provided by head support assembly 30. Rotation of knob 74 with knob gear 81 triggers compression spring 78 thereby increasing the force that compression spring 78 applies to trigger cable assembly 71. The knob 74 may be configured to operatively couple to pulley 84 with knob shaft 77.

In some embodiments, the pulley 84 is for winding and rewinding cable from cable assembly 71. A pawl 75 is a stopper, which works in two ways. For example, when knob 74 is in released position, the pawl 75 will prevent the knob 74 from slipping in anti-direction. Further, when knob 74 is moved back to normal position, the pawl 75 will release pressure, allowing pulley 84 to rewind the cable from cable assembly 71 by resisting anti-rotation of the knob gear 81. The pawl 75 may be operatively connected to a spring 82. The knob 74 may be configured to engage knob gear 81 and pulley 84 to operatively connect to an end portion of the one or more cables of cable assembly 71. The pawl 75 may function to vary an engagement force between the knob gear 81 and pulley 84, thereby controlling the amount of cable is winded on pulley 84 when the knob 74 is rotated. The pawl 75 may also function to limit the traction forces applied by the traction device 10. In some embodiments, the pawl 75 may function to prevent excessive forces applied by the traction device 10.

In some embodiments, pawl 75 may function as a safety measure, to prevent excessive traction forces or other forces from being applied. The traction force applied may be limited to the desired traction limit set by knob 74. Thus, the force may be controlled, adjusted, or limited. Handle assembly 70 may include or be used in conjunction with any embodiment disclosed herein. Front facing bracket 72 and back facing bracket 73 may be assembled that facilitates selective locking respect to pulley 84. Reversing the direction of rotation of knob 74 rotates pulley 84 and pulley gear 81 to rewind the cable in cable assembly 71. Rotating knob 74 in a clockwise direction may be operated to increase the extent of compression spring 78 that is for applying traction force on internal drive assembly 60 and rotating knob 74 in a counter clockwise direction may be operated to compress the compression spring 78 that is for applying counter-traction force on internal drive assembly 60. The front facing bracket 72 and back facing bracket 73 forms a compact casing in which all these are assembled to form a compact handle assembly 70.

The handle assembly 70 may include cable assembly 71, front facing bracket 72, back facing bracket 73, knob 74, pawl 75, handle 76, knob shaft 77, compression spring 78, slider 79, knob gear 80, pulley gear 81, spring 82, and pulley 84. Handle assembly 70 may include or be used in conjunction with any embodiment disclosed herein.

Knob 74 may be configured to set the traction limit. Knob 74 may be configured to rotate the cable of cable assembly 71 to move internal drive assembly 60 along with the head assembly 30 thereby increasing or decreasing traction. In one embodiment, knob 74 may be configured to apply course or greater movement of internal drive assembly 60 and handle 76 may be configured to apply fine or less movement of internal drive assembly 60. Alternatively, knob 74 and handle 76 may have an opposite configuration. Pawl 75 may be configured to releasably engage knob gear 81. When handle 76 is actuated (i.e. squeezed), pawl 75 may be engaged into the teeth of knob gear 81 with pressure from spring 82, thereby rotating and/or actuating gear assembly. When handle 76 is released, pawl 75 may disengage the teeth on known gear 81 by rotating and depressing compression spring 78. Spring 82 is used to disengage handle 76 while the knob 74 is used to release traction. Handle assembly 70 may include or be used in conjunction with any embodiment disclosed herein. Pulley 84 may be configured to receive and wrap the cable of cable assembly 71. Knob 74 may set the traction limit. Knob 74 may increase or decrease tension on the cable of cable assembly 71. Handle assembly 70 may include or be used in conjunction with any embodiment disclosed herein.

The handle assembly 70 may include cable assembly 71, front facing bracket 72, back facing bracket 73, knob 74, pawl 75, handle 76, knob shaft 77, compression spring 78, slider 79, knob gear 80, pulley gear 81, spring 82, and pulley 84. Pulley 84 may be configured to rotationally receive and wrap the cable of cable assembly 71. Handle assembly may also be configured with anti-reversing features. Slider 79 may allow movement of compression spring 82 to advance the cable assembly 71. As such, the cable assembly 71 may advance the internal drive assembly 60 with respect to frame assembly 40, but the anti-reversing features may stop the cable from reversing into handle assembly 70 and/or reduce cable slack on pulley 84. Handle assembly 70 may include or be used in conjunction with any embodiment disclosed herein.

The handle assembly 70 may longitudinally and/or rotationally translate a force from the handle assembly 70 to the internal drive assembly 60, for example by increasing or decreasing tension or rotation of a knob 74 or handle 76. The internal drive assembly 60 may apply a force to the head assembly 30, for example with a handle assembly 70. Actuation of the handle assembly 70 ultimately translates a force to the head assembly 30 and angular neck support assembly 20 thereby controllably applying a force to the cervical spine.

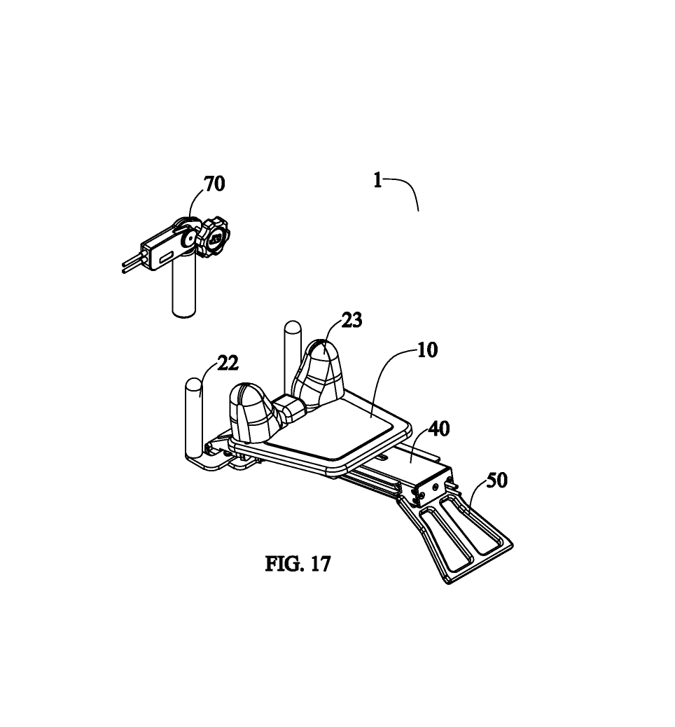

Referring to FIG. 17, cervical traction system 1 may include traction device 10 and handle assembly 70. The traction device 10 includes a stationary base plate 21, an angular neck support assembly 20, head support assembly 30, a frame assembly 40, an internal drive assembly 60, an angular support 50, and a handle assembly 70. The frame assembly includes two side rails 44 and 45 secured in the frame assembly 40, generally by welding or screws. Alternatively, the side rails can be secured in any known manner including, but not limited to, gluing. The side rails 44 and 45 provide support to internal drive assembly 60 for linear movement related to the frame assembly 40.

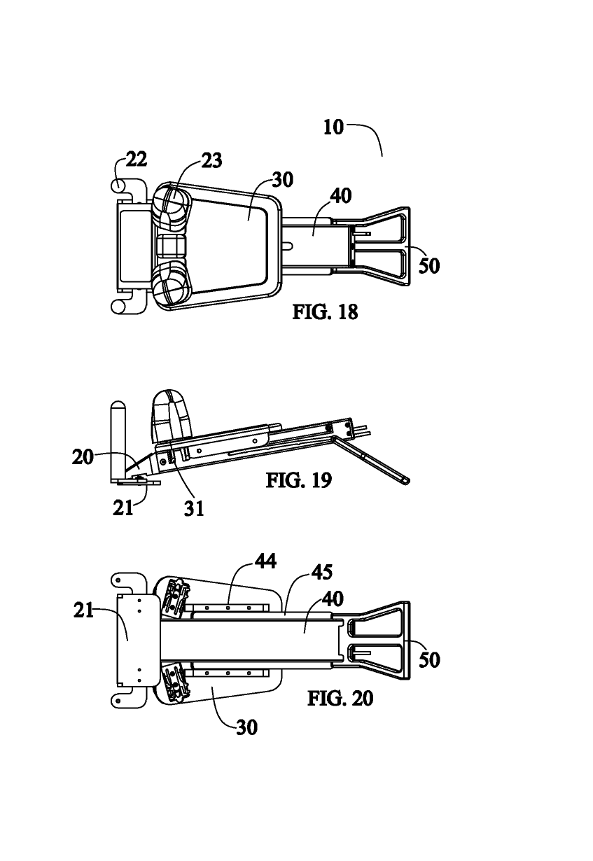

Referring to FIGS. 17-21, in another embodiment, the cervical traction system 1 may include a traction device 10 including a stationary base plate 21, angular neck support assembly 20, head support assembly 30, frame assembly 40, internal drive assembly 60, angular support assembly 50, cable assembly 71, and a handle assembly 70. The frame assembly 40 has two frame side rails that are attached to edges of frame assembly 40. The side rails 44 and 45 are secured in frame assembly 40, generally by welding or screws. These side rails 44 and 45 provide support to internal drive assembly 60 for linear movement related to the frame assembly 40. The frame assembly 40 may be configured to connect 50 angular supports to establish an angle between the stationary base plate 21 and the frame assembly 40. The frame assembly 40 comprises a groove in both sides for slidably mounting angular support 50 with screws. The head support may be configured to include occipital supports 23 and occipital adjuster 31 configured to stabilize a portion of a head of a user. The angular neck support assembly 20 may be configured to include shoulder adjuster and shoulder up-rest 22 plate to receive a portion of a neck.

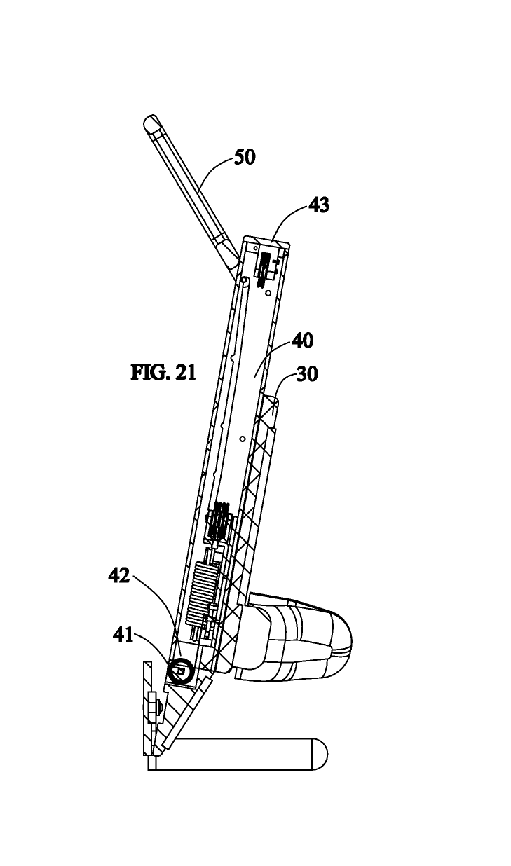

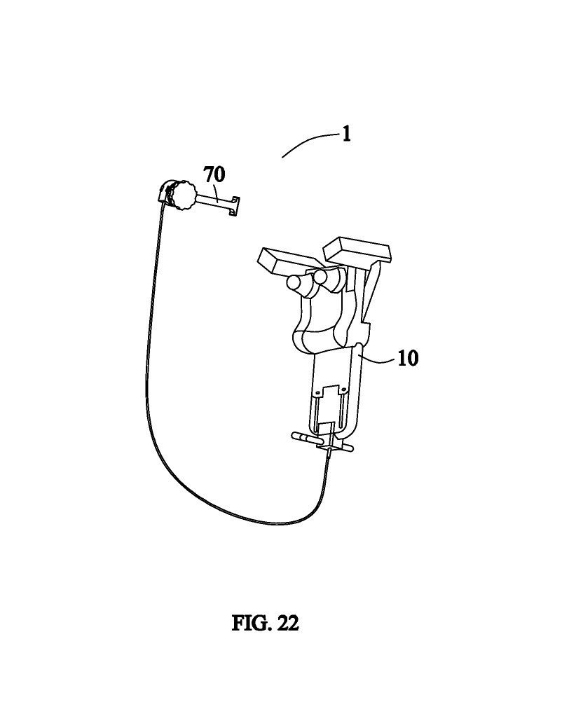

In one non-limiting embodiment, as shown in FIGS. 21-22, cervical traction system 1 may include traction device 10 and handle assembly 70. The frame assembly 40 may include one or more frame struts configured to define a fixed position for a user, against which the head support assembly 30 may move. The frame assembly 40 may comprise a single frame strut bent in a U-shape, in which one end of the U-shape is disposed toward the top of the head assembly 30, while the other end of the U-shape is disposed toward shoulders of a user. Further, the frame assembly may include one or more shoulder stabilizers. The shoulder stabilizers may be located at or near the end of the frame assembly 40. The shoulder stabilizers may configure to engage the superior portion of the shoulders. Non-limiting examples of such features may include curved portions to distribute one or more counter-traction forces on the superior portion of the shoulders and padded portions to reduce pressure damage to the shoulder tissue, and one or more rotational connections to the frame assembly 40 to adjust the angle of the shoulder stabilizers with respect to the one or more frame struts.

The head support assembly 40 may include one or more head stabilizers, one or more movable pulleys, and one or more frame guides. The head support assembly 40 may be fabricated from any material including a plastic, a rubber, a cloth, a metal, or any combination thereof. The one or more head stabilizers may be configured to stabilize a position of head or neck with respect to the head support assembly 40. In other non-limiting embodiments, the head stabilizers may be independently adjustable in their respective heights with respect to a surface of the head support assembly 40. In some non-limiting embodiments, the one or more frame guides may be configured to slidably engage one or more of the frame struts. In one non-limiting example, the frame guides may be fabricated from one or more low-friction materials (for example, polytetrafluoroethylene).

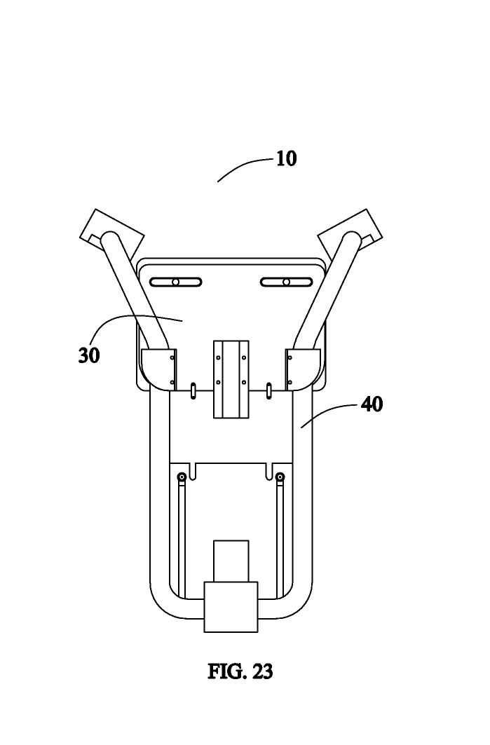

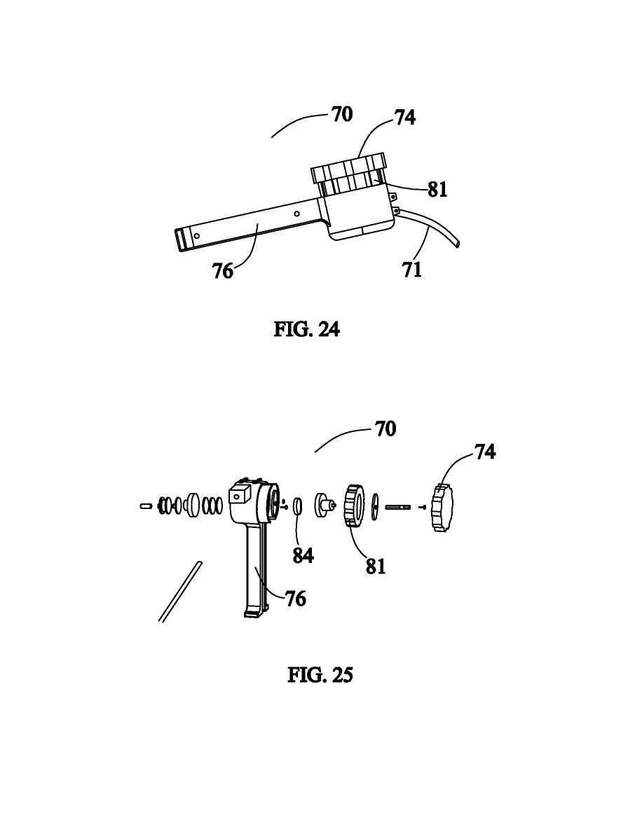

Further, in one non-limiting embodiment, as shown in FIGS. 23-24, the handle assembly 70 may include a handle 76, a crank component 74, and a clutch component 81. The handle assembly may include indicia or markings corresponding to relative positions of the crank component 74 or clutch component 81, which there by indicate one or more traction force amounts or traction force limits. The handle 76 may be shaped in any manner to permit an operator to hold the handle assembly 70 in any position relative to the traction system 1. The crank component 74 may be used by an operator to generate a force on the one or more cables 71 capable of moving the head support assembly 30 relative to the frame assembly 40. The crank component 74 may be configured to engage a winding component 84, such as a spring, a spool, or the like, with an end portion of the one or more cables 71. The clutch component 81 may function to vary an engagement force between the crank component 74 and the winding component 84, there by controlling the amount of cable 71 taken up by the winding component 84 when the crank component 74 is rotated or engaged. The clutch component 81 may also function to limit the traction forces applied by the traction system 1. In some embodiments, the clutch component 81 may function to prevent the subject from receiving excessive forces applied by the traction system 1. In some embodiments, the clutch component 81 may function as a safety measure, to prevent excessive traction forces or other forces from being applied to the subject. The variable engagement force may be provided by, for example, a compression spring or a constant force spring configured to engage the clutch component 81, the crank component 74, and/or the winding component 84.

The pulley system may be configured to provide a mechanical advantage to the actions of the operator using the handle assembly 70. Non-limiting configurations of the pulley system may include a gun tackle configuration, a luff tackle configuration, a double tackle configuration, a gyn tackle configuration, and a threefold purchase configuration. The clutch component 81 may function to vary an engagement force between the crank component 74 and the winding component 84, thereby controlling the amount of cable 71 taken up by the rotation or engagement of the crank component 74. The crank component 74 and clutch component 81 of the handle assembly may be adjusted by the user to increase, decrease, control, limit, or otherwise set or alter the amount of cable 71 taken up by the rotation or engagement of the crank component 74, thereby altering the amount of the traction force applied to the cervical spine.

One or more additional counter-traction forces may be applied to the head support assembly 30 through a return bias spring assembly, which may include one or more return bias springs. The return bias spring assembly may comprise a constant force spring. The constant force spring may be coupled to the frame assembly 40 and the head support assembly 30, for example on a surface of the head support assembly 30. As the head support assembly 30 moves towards the at least one fixed pulley, the constant force spring may unwind, thereby creating a restoring force against the head support assembly 30. In another non-limiting embodiment, the return bias spring assembly may comprise a compression spring. In one non-limiting example, the compression spring may couple the head support assembly with a structure associated with the frame assembly. As one example, the compression spring may be in association with one or more portions of the cable between the at least one fixed pulley and the at least one movable pulley. In another non-limiting example, a compression spring may be covered in a shroud. The shroud may protect the compression spring from interference, such as from a subject's hair. In another non-limiting example, the cables or other mechanical, pneumatic, or hydraulic components may be incorporated into or near the frame assembly itself. In a non-limiting example, the frame assembly may partially or completely conceal the cables or other mechanical, pneumatic, or hydraulic components.

It may be understood that the traction system 1 may include additional components configured to provide additional stabilization of the subject with respect to the device. In some non-limiting examples, the additional components may include one or more of a head strap, a chin strap, and a torso strap.

The embodiments herein may be manufactured with any material or process suitable for medical use or to provide traction or distraction to a portion of a body. For example, embodiments may include any metal, polymer, or elastic material.

All or any portion of any embodiment herein may include any combination of the embodiments disclosed herein. As used herein, an element or act recited in the singular and proceeded with the word “a” or “an” should be understood as not excluding plural elements or acts unless such exclusion is explicitly recited. Furthermore, references to “embodiment” or “embodiments” of the present disclosure are not intended to be interpreted as excluding the existence of additional embodiments. Moreover, reference numbers including letters are intended to provide example locations with respect to the drawings but are not intended to be interpreted as limiting their interchangeability with any embodiments herein.

The foregoing description of embodiments of the disclosure has been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated.

Certain features of the embodiments of the claimed subject matter have been illustrated as described herein; however, many modifications, substitutions, changes, and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

What is claimed is:

1. A cervical traction system, the system comprising:
a head support assembly;
a frame assembly;
a displacement assembly in mechanical communication with the head support assembly and the frame assembly;
an adjustment assembly in mechanical communication with the frame assembly; and
a handle assembly configured to control the displacement assembly.

2. The system of claim 1, wherein a movement of the head support assembly relative to the frame assembly applies one or more traction forces to one or more of the head of the subject and a neck of the subject.

3. The system of claim 1, wherein the head support assembly comprises at least one head stabilizer configured to stabilize a portion of a head of a subject.

4. The system of claim 1, wherein the displacement assembly comprises one or more of a pulley system, a pneumatic system, a hydraulic system, and mechanical system.

5. The system of claim 1, wherein the displacement assembly comprises a pulley system having at least one fixed pulley in mechanical communication with the frame assembly and at least one movable pulley in mechanical communication with the head support assembly.

6. The system of claim 1, wherein the frame assembly further comprises at least one shoulder stabilizer.

7. The system of claim 1, wherein the adjustment assembly is a height adjustment assembly.

8. The system of claim 1, wherein the adjustment assembly is an angle adjustment assembly.

9. The system of claim 1, wherein the handle assembly comprises a crank component, a clutch component, and a winding component, the handle assembly operatively connected to a cable, wherein the cable is in mechanical communication with at least one fixed pulley and at least one movable pulley.

10. The system of claim 1, further comprising one or more frame guides affixed to the head support assembly and configured to slidably contact the frame.

11. The system of claim 1, wherein the head support assembly is configured to conform to the head of the subject.

12. The system of claim 3, wherein the at least one head stabilizer comprises a first head stabilizer and a second head stabilizer.

13. The system of claim 12, wherein the first head stabilizer and the second head stabilizer are independently positionable on the head support assembly.

14. The system of claim 3, wherein the head support assembly further comprises a head strap.

15. The system of claim 1, further comprising a return bias spring assembly configured to apply a restoring force to the head support assembly.

16. The system of embodiment 15, wherein the return bias spring assembly comprises a constant force spring.

17. The system of embodiment 15, wherein the return bias spring assembly comprises a compression spring.

18. A method of using a cervical traction system, the method comprising:
providing a cervical traction system, the system comprising a head support assembly, a frame assembly, a displacement assembly in mechanical communication with the head support assembly and the frame assembly, an adjustment assembly in mechanical communication with the frame assembly, and a handle assembly configured to control the displacement assembly;
positioning a head and a neck of a subject with respect to the head support assembly the cervical traction system;
activating the handle assembly; and
moving the head support assembly relative to the frame assembly.

19. The method of claim 18, wherein moving the head support assembly comprises adjusting a crank component and a clutch component of the handle assembly, thereby engaging a winding component of the handle assembly to adjust the displacement assembly.
